(19) United States
(12) Patent Application Publication
(10) Pub. No.: US 2006/0076408 A1
(43) Pub. Date: Apr. 13, 2006

(54) Inventory assisting assembly and method of using same

(76) Inventors: William A. Phillips, Lake Orion, MI (US); Michael Gelaude, Highland, MI (US); Bill Kosiba, Canton, MI (US); Martyn Glover, Tecumseh (CA)

Correspondence Address: David J. Simonelli, Esq.;Clark Hill PLC, Suite 3500, 500 Woodward Ave., Detroit, MI, 48226-3435, US

(21) Appl. No.: 10/961,794

(22) Filed: Oct. 8, 2004

(51) Int. Cl. G06Q 30/00

(52) U.S. Cl. 235/385

(57) ABSTRACT

An inventory assisting system coordinates activity relating to the acts of receipt and inventory of motor vehicles in a lot wherein each of the motor vehicles has a vehicle identification number and a graphic representation of the vehicle identification number. The inventory assisting assembly includes a wireless device capable of transmitting data signals using electromagnetic radiation. A scanner is operatively connected to the wireless device for scanning the graphic representation of the vehicle identification number and for transmitting the data to the wireless device. The scanned data is converted into data signals for transmission. The inventory assisting assembly also includes a server designed to receive the data signals from the wireless device and for transforming the data signal into a readable output identifying all characteristics of the motor vehicle that are encoded in the vehicle identification number.

### BACKGROUND ART

1. Field of the Invention

The invention relates to inventory assemblies for dealers of motor vehicles. More particularly, the invention relates to an inventory assisting assembly that reduces manual inputs to have data more accurately reflect the status of a dealer lot at any particular time and reduce the time required for creating print materials for the inventory process.

2. Description of the Related Art

Dealerships for motor vehicles incorporate inventory systems into their best practices to balance the requirement for an adequate inventory for customer satisfaction and not too much inventory that it will be a financial burden to the dealership. Many of the inventory procedures found at dealerships involve multiple manual steps. When a motor vehicle arrives, an employee of the dealership must record the vehicle identification number and, in many instances, must record that vehicle identification number in several different places. Each time, the person has an opportunity to make a mistake. After the vehicle identification number is recorded manually, it must be entered into a database. This database may be a stand-alone database, or it may be a networked database in which other dealerships may have an opportunity to view it.

Additionally, the keys for the motor vehicle must be identified. Keytags must be affixed to the keys for that particular motor vehicle. This requires additional transcribing of the vehicle identification number. A further delay in having the motor vehicle be ready for sale is the preparation of paperwork regarding the motor vehicle. More specifically, the features found in the motor vehicle are not readily discernable and the motor vehicle must be investigated to determine what features are present. All of the paperwork required when taking delivery of a motor vehicle needs to be created before the motor vehicle can be sold. The man hours required to create the paperwork and the time in which the motor vehicle sits on a lot waiting to be readied for sale raises the costs of doing business.

There are systems that incorporate electronic devices to automate these processes. They rely exclusively to dedicated systems that are usually installed at the dealership. Once installed, they operate in a region close to the central processing unit (CPU) that was installed because they are typically radio-based systems. If the CPU was installed in a dealership showroom, it may not be able to extend its reach to the service center or parking lot of the dealership where information is input. Therefore, the systems have input and output values that are not synchronized with each other. This causes problems if one is to rely on one set of data or the other.

### SUMMARY OF THE INVENTION

An inventory assisting system coordinates activity relating to the acts of receipt and inventory of motor vehicles in a lot wherein each of the motor vehicles has a vehicle identification number and a graphic representation of the vehicle identification number. The inventory assisting assembly includes a wireless device capable of transmitting data signals using electromagnetic radiation. A scanner is operatively connected to the wireless device for scanning the graphic representation of the vehicle identification number and for transmitting the data to the wireless device. The scanned data is converted into data signals for transmission. The inventory assisting assembly also includes a server designed to receive the data signals from the wireless device and for transforming the data signal into a readable output identifying all characteristics of the motor vehicle that are encoded in the vehicle identification number.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of a lot of a dealer with a plurality of motor vehicles, each with a printout from one embodiment of the invention;

FIG. 2 is a graphic representation of a print out of a sheet of a plurality of stickers;

FIG. 3 is a graphic representation of one embodiment of the invention;

FIG. 4 is a graphic representation of one embodiment of the invention; and

FIGS. 5 through 10 are logic charts associated with one embodiment of the method for inventorying motor vehicles.

### DETAILED DESCRIPTION OF THE PREFERRED EMBODIMENT

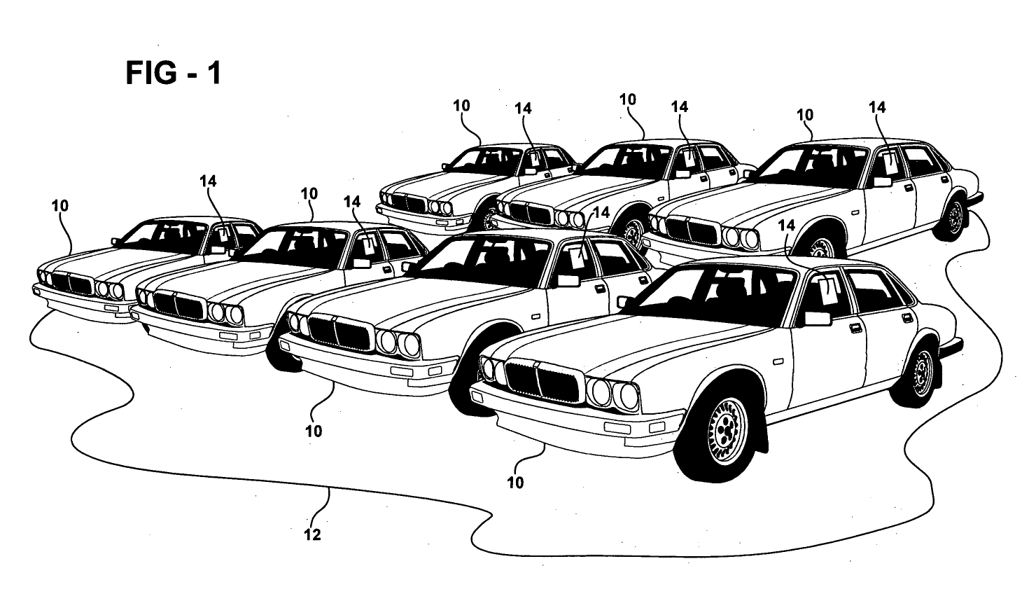

Referring to FIG. 1, a group of motor vehicles 10 are shown. The motor vehicles 10 are in a dealer lot 12 awaiting sale and/or delivery. Each of these motor vehicles 10 has a unique set of characteristics and a unique vehicle identification number. In addition, each of these motor vehicles includes a window sticker 14 that identifies many of the options in each of the motor vehicles 10. Therefore, each of the window stickers 14 has information that differs from each other to the extent that each of the motor vehicles 10 have different options and characteristics, e.g., exterior color, interior color, engine size, and the like.

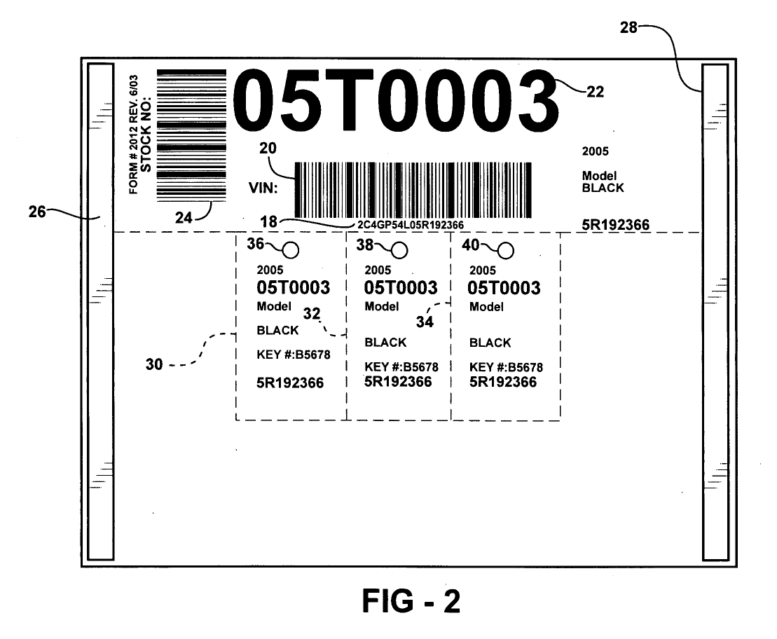

When a dealer takes delivery of a motor vehicle 10, the dealer must take several steps to accept the motor vehicle 10 into its inventory. The paperwork associated with the delivery of a motor vehicle into a dealer's inventory requires the generation of several folders of information. These folders need to be labeled and the options in the vehicle must be identified with the motor vehicle 10. Because the best way to identify a vehicle is by its vehicle identification number, this number is repeatedly written down on all of the folders and paper work associated with the particular motor vehicle. Referring to FIG. 2, an identifying window sticker 16 shows a vehicle identification number 18 and a graphic representation of the vehicle identification number 18. In the embodiment shown in the Figures, the graphic representation 20 of the vehicle identification number 18 is a barcode. A large, identifiable number 22 is the stock number which is particular to the particular dealer and/or the dealer lot 12. A graphic representation 24 of the stock number 22 is shown on the left side of the identifying window sticker. The identifying window sticker 16 includes first 26 and second 28 strips of adhesive. Theses two strips of adhesive 26, 28 have plastic covers covering the adhesive 26, 28 allowing the identifying window sticker 16 to be carried and handled easily prior to it being applied to the window of the motor vehicle 10. The first 26 and second 28 strips of adhesive are on either side of the identifying window sticker 16. To aid in the confirmation that the identifying window sticker 16 is for a particular motor vehicle 10, some information is shown on the right side of the identifying window sticker 16. In particular, the year, model, exterior color and the last several digits of the vehicle identification number 18 are shown allowing someone to readily identify the motor vehicle 10 and confirm that the identifying window sticker 16 belongs thereto.

Directly below the identifying window sticker 16 are three keytags 30, 32, 34. Each of these keytags 30-34 include holes 36, 38, 40 to receive key rings therethrough. The identifying window sticker 16 and each of the keytags 30, 32, 34 are all fabricated from the same sheet of paper. This prevents multiple errors in the regeneration of each of these four individual documents upon their preparation.

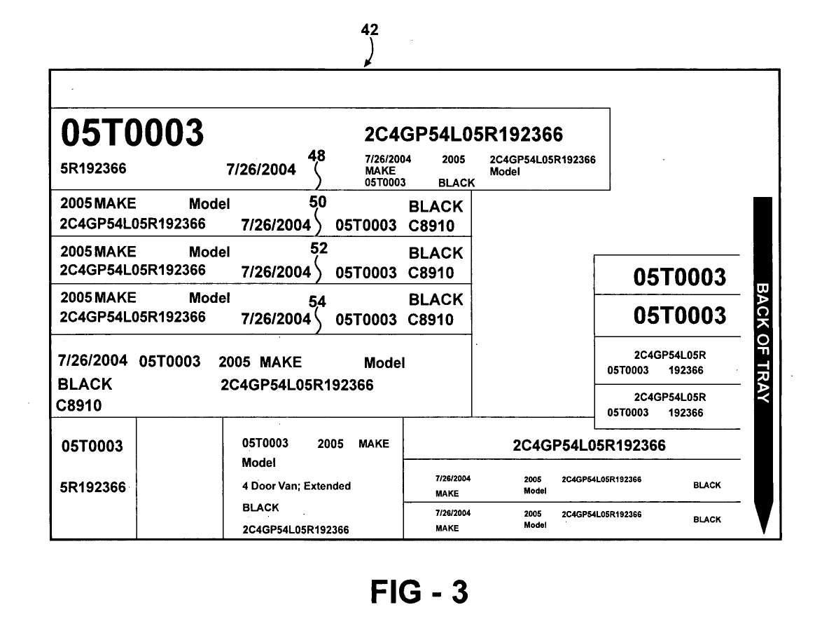

Referring to FIG. 3, a sheet of stickers is generally indicated at 42. The sheet of stickers 42 includes a plurality of stickers 44 all of multiple sizes and containing different pieces of information. These various stickers 44 are affixed to various papers and folders required by the dealer to maintain an accurate inventory of the dealer lot 12 and provide organized sales and service forces with the appropriate information and the appropriate files to convey the information to customers of the dealer. This sheet of stickers 42 is printed at the same time as the identifying window sticker 16 and has the same information that was input into the inventory processing assembly 46, discussed in greater detail subsequently. By having a single point of generation of all of the printed materials, the number of errors is kept to a minimum. As may be appreciated, there are long thin stickers 48, 50, 52, 54 that are designed to be affixed to folders. Other stickers of varying sizes and dimensions are used for other forms and paperwork that may be needed by the dealer to operate the business of selling motor vehicles 10.

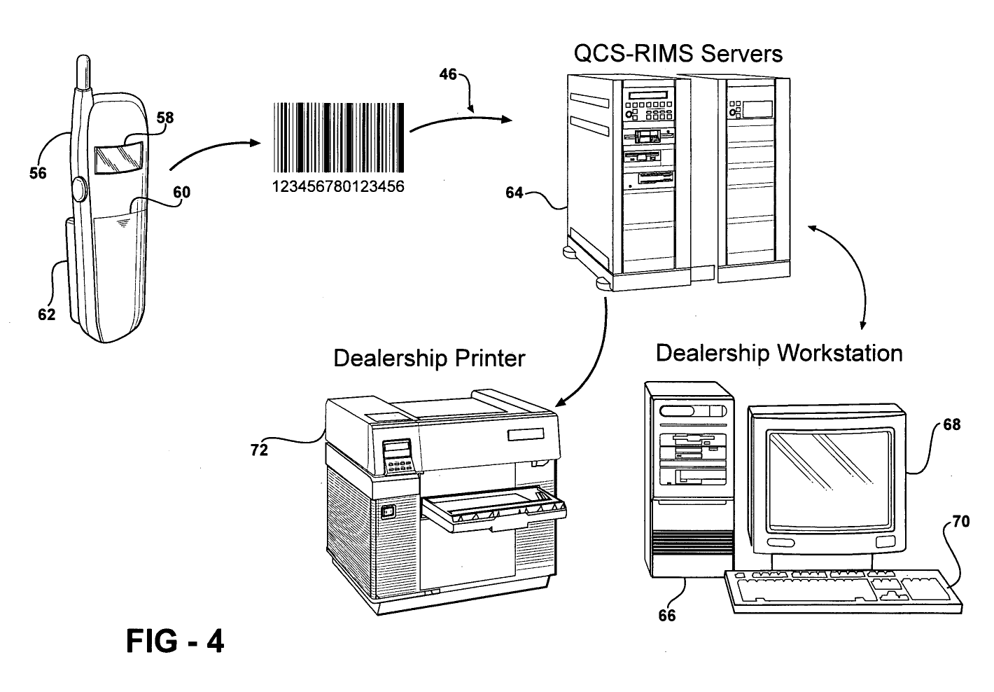

Referring to FIG. 4 the inventory assisting assembly is generally indicated at 46. The inventory assisting assembly 46 coordinates the activity related to the acts of receipt and inventory of the motor vehicles 10 in the lot 12 wherein each of the motor vehicles 10 has the vehicle identification number 18 and a graphic representation 20 thereof. As was discussed above, the acts relating to the receipt and inventory of the motor vehicles 10 includes creating the window sticker 14, the identifying window sticker 16, keytags 30-34, and the sheet of stickers 42. Also included in the acts of receiving and inventorying motor vehicles 10 includes identifying the location of the motor vehicle 10 in a particular lot 12 should a dealer have more than one lot 12, which is often the case.

The inventory assisting assembly 46 includes a wireless device 56. The wireless device 56 may be a mobile telephone, as shown in FIG. 4, or another type of personal digital assistant (PDA). The wireless device 56 includes a screen 58 capable of displaying the vehicle identification number 18 and other information related to the inventory process. The wireless device 56 must be capable of transmitting data signals using electromagnetic radiation and, in particular, electromagnetic radiation in the radio frequency spectrum thereof. The wireless device 56 also includes an input keypad 60 providing the ability to keystroke in alphanumeric information into the wireless device 56. In the preferred embodiment, the data is transmitted via a proprietary wireless cellular based data network provided by Nextel.

The inventory assisting assembly 46 also includes a scanner 62. The scanner 62 is operatively connected to the wireless device 56 and scans the graphic representation 20 of the vehicle identification number 18. In the preferred embodiment, the scanner 62 is a module that is secured to the wireless device 56. The scanner 62 creates scanned data that is transmitted to the wireless device 56, which is then converted to the data signals that are transmitted by the wireless device 56. In the preferred embodiment, the scanner 62 is a barcode scanner and the graphic representation 20 of the vehicle identification number 18 is a barcode representation of the vehicle identification number 18.

The inventory assisting assembly 46 also includes a server 64. The server 64 is at a location remote from the dealer. The server 64 receives the data signals transmitted from the wireless device 56. The server 64 includes software capable of decoding the vehicle identification number 18 to extract as much information therefrom as possible. By way of background, the vehicle identification number 18 is coded such that certain physical properties of the motor vehicle 10 are identifiable through the vehicle identification number 18. The software in the server 64 is capable of decoding the vehicle identification number 18 to provide the options and features available in that particular motor vehicle 10.

The inventory assisting assembly 46 also includes a dealership work station 66. The dealership work station 66 is a computer that is remote from the server 64 and located at the dealer. It may be connected to the server 64 via the internet (not shown). The dealership work station 66 includes a monitor 68 and a web browser, allowing an operator the ability to view information provided by the server 64. In addition, the dealership work station 66 has a keyboard 70 providing the user of the dealership work station 66 the ability to input data regarding a particular vehicle record created by the server 64. The dealership work station 66 provides a bi-directional line of communication between the server 64 and the dealership work station 66 such that an operator of the dealership work station 66 can see the information decoded from the vehicle identification number by the server 64 and, at the same time, is able to input additional information into the vehicle record for the motor vehicle 10 where it is stored by the server 64. By way of example, the vehicle identification number 18 does not encode the option of the type of stereo system that is installed in the motor vehicle 10. The operator of the dealership work station 66 may know that there is a multi-port CD player as a part of the stereo system of the motor vehicle 10. The operator of the dealership work station 66 may enter that data where it is stored in the vehicle record of the motor vehicle 10 and that information may be stored in a central location and easily retrieved by any one of a number of dealership work stations 66 that may be on the premise of the dealer.

The inventory assisting assembly 46 also includes a printer 72. The printer 72 prints out the sheets of stickers 42, the identifying window sticker 16 and the keytags 30-34. The printer 72 is located at the dealer and may be connected with the dealership work station 66, either directly or through a local area network. In the embodiment shown in FIG. 3, the printer 72 is connected to the server 64. The printer 72 receives the information on the vehicle record to print the identifying window sticker 16, the keytags 30-34 and the sheet of stickers 42 from information it receives from the server 64 directly and not from the dealership work station 66. This maintains the integrity of the vehicle record.

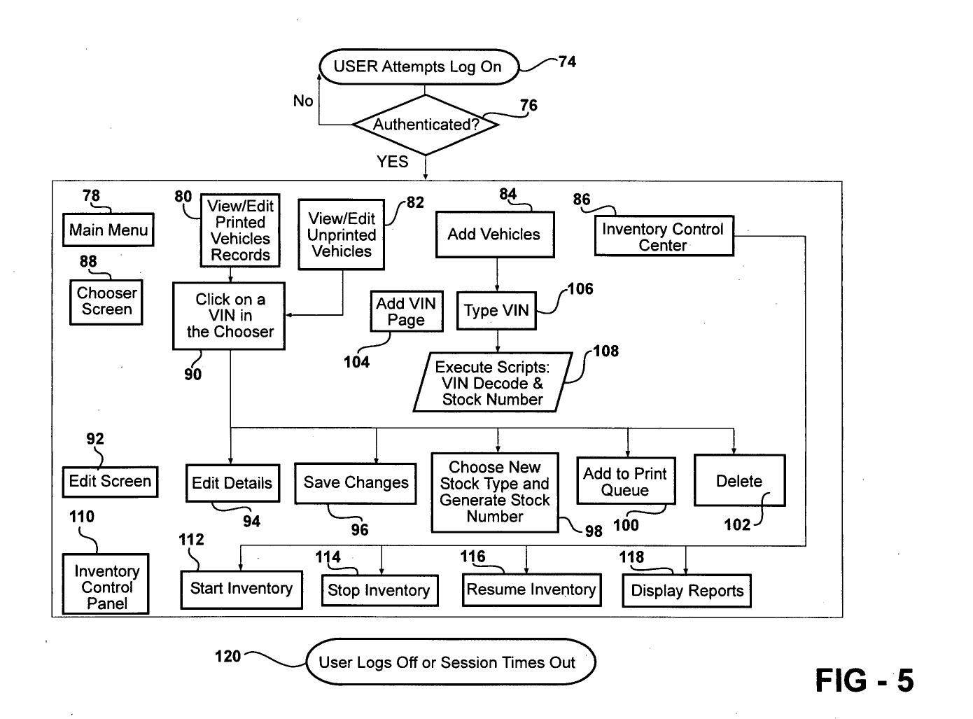

Referring to FIG. 5 a logic chart shows an overall diagram of how the method for assisting in the inventory process of motor vehicles 10 using the wireless device 56 is performed. It begins at 74 when the user of the method attempts to log on. Upon authentication, at 76, the user enters the method of operation. If not, the method loops back and allows the user to attempt to log on again at 74. The method is contemplated to be operated from one of two types of sources namely, the dealership work station 66 or the wireless device 56. Both of these devices 56, 66 will have the ability to log on users and authenticate users. It should be appreciated by those skilled in the art that there may be any number of wireless devices 56 and dealership work stations 66 for a particular dealership.

Once authenticated, the method shows a main menu 78. The main menu 78 provides the user the opportunity to view or edit vehicle records at 80, view and edit vehicle records that have yet to be printed at 82, add vehicles at 84 or enter the inventory control center at 86. It should be appreciated that the inventory assisting assembly 46 and the method work hand-in-hand with the inventory system that is utilized by the dealer. More specifically, the inventive method interfaces with the inventory system used by the dealer to more accurately identify the status of the inventory while reducing errors by facilitating the printing of various printed items automatically. If the user selects to view or edit printed vehicle records at 80 or unprinted vehicle records at 82, the user is then directed to a chooser screen 88. The user is then able to choose a vehicle identification number at 90. Once the vehicle identification number is chosen, the user is directed to an edit screen 92 where the user may edit details at 94, save changes at 96, choose the new stock type and generate a new stock number at 98, add to the print cue at 100 or delete a record at 102.

If the user wishes to add a vehicle record at 84, the user is directed to an add vehicle identification number page 104, wherein the user types in the vehicle identification number at 106 and the algorithm that decodes the vehicle identification number and generates a stock number for the dealer is performed at 108.

If the user selects the inventory control center 86, the user is then directed to an inventory control screen 110 where the dealer can then start an inventory 112, stop and inventory 114, resume an inventory at 116 and/or display reports at 118. Upon completion of all of these tasks by the user, the user logs off or the session times out at 120.

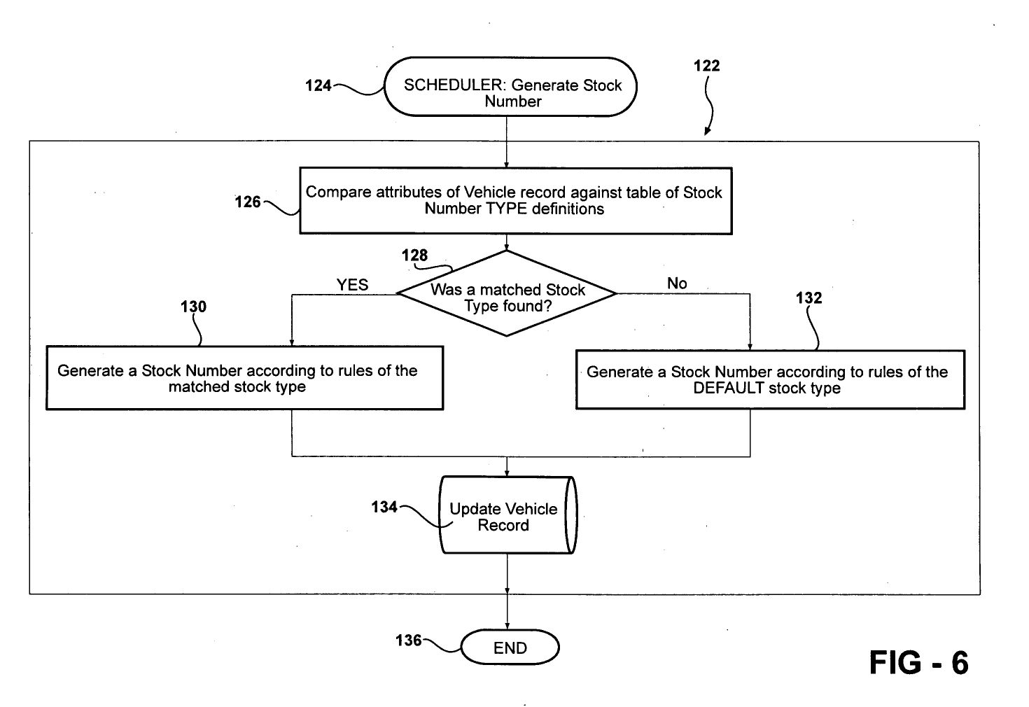

Referring to FIG. 6, a subroutine showing how a stock number is generated is generally shown at 122. The method begins at 124. The first step is the comparison of attributes of the vehicle record against a table of stock type definitions at 126. It is then determined at 128 whether a match in the stock type was found. If so, a stock number according to the rules of the matched stock type is generated at 130. If not, a stock number is generated according to the rules of a default stock type that will represent that the stock number for the particular motor vehicle 10 was generated without having a specific stock type. The vehicle record is then updated at 134 and the subroutine ends at 136.

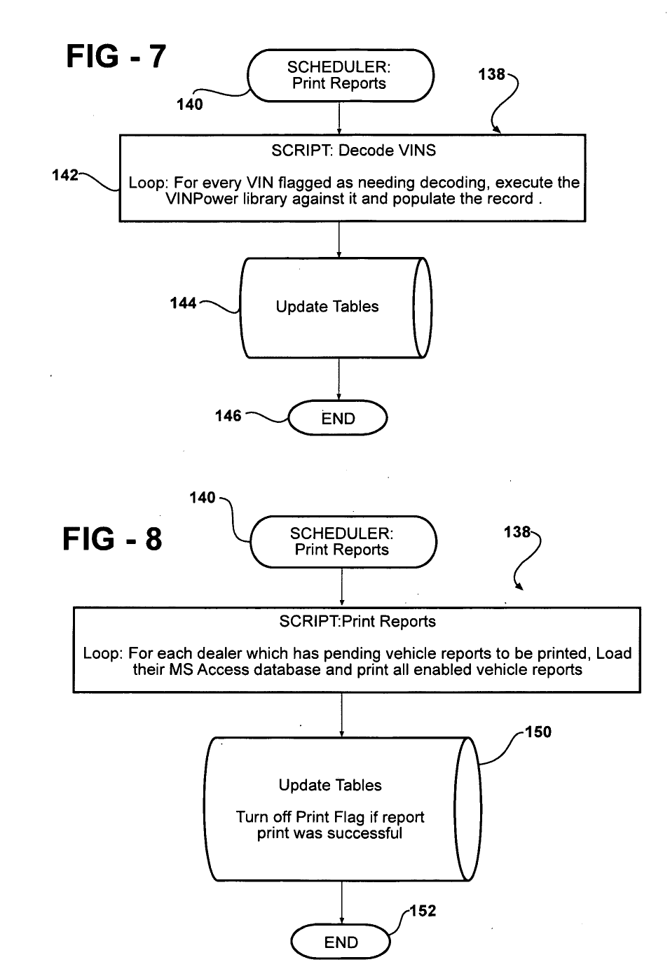

With reference to FIG. 7, a subroutine regarding the printing of reports is generally indicated at 138. This scheduler subroutine 138 begins at 140. A routine loop 142 identifies a vehicle identification number 18 as flagged and in need of decoding. The loop 142 executes the subroutine identified as 108 in FIG. 5 to populate the vehicle record with all the information that is decoded from the vehicle identification number 18. The tables that store information regarding the inventory on the dealer lot 12 are updated at 144 and the subroutine terminates at 146.

The print report subroutine 138 continues in FIG. 8. This position of the subroutine begins at 140 by identifying when a report is to be printed. Once identified, a program loop 148 identifies when vehicle reports are to be printed and prints those vehicle reports at the printer 72 for that particular dealer. The tables regarding the pending vehicle report printouts are updated at 150 and the subroutine ends at 152.

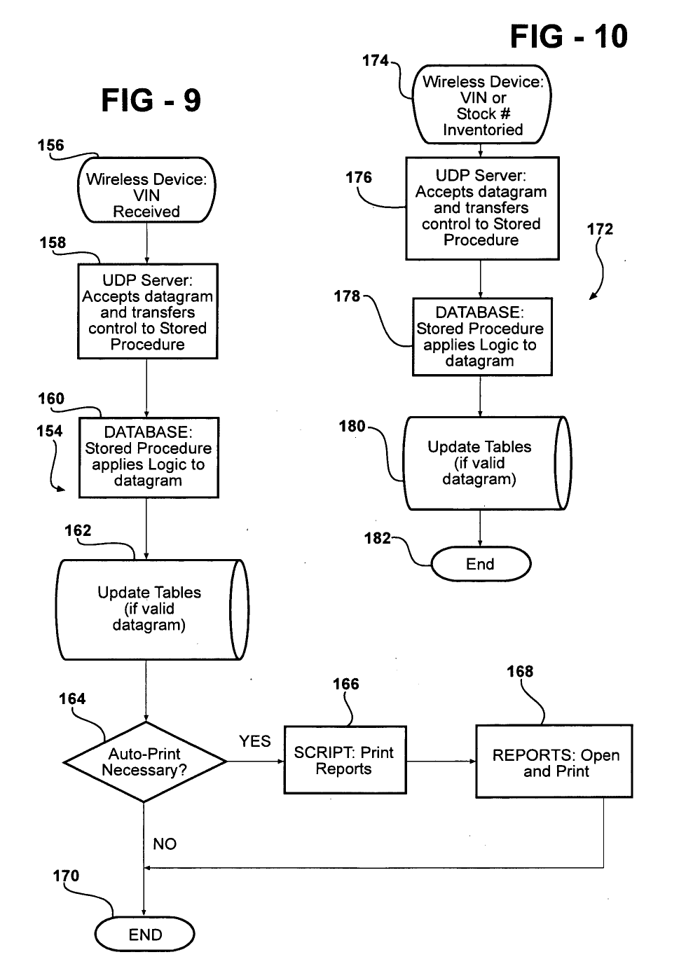

Referring to FIG. 9, a subroutine identifying when a wireless device 56 is used to update a database of a dealer lot 12 is generally indicated at 154. The subroutine begins at 156 where the wireless device receives a vehicle identification number 18. Receipt of the vehicle identification number 18 may be done one of two ways. The wireless device 56 may utilize its input keypad 60 to have the vehicle identification number 18 input. Alternatively, the wireless device 56 may have a scanner 62 attached thereto that scans the graphic representation of the vehicle identification number 20.

Regardless, the scanned data or input data is transferred to the server 64 at 158. The server 64 accepts the transmitted data signals that were transmitted by the wireless device 56 and invokes a storage procedure to store the vehicle identification number 18 at 160. The tables are updated at 162. It is then determined whether an auto print is necessary at 164. If so, the print scripts of FIGS. 7 and 8 are invoked at 166, the reports are printed at 168 and the subroutine ends at 170. If an auto print is not necessary, the subroutine does not print anything and immediately terminates at 170.

Referring to FIG. 10, a subroutine regarding the inventory procedure is generally indicated at 172. The subroutine begins at 174 where a vehicle identification number 18 or stock number 22 is inventoried. The server 64 then accepts the information and transfers it to a store procedure at 176. The database applies logic to the data signals received and stores the information relating to the vehicle identification number 18 or the stock number 22 at 178. The tables of the inventory are updated at 180 and the subroutine is terminated at 182.

With regard to the logic that is applied at 178, the method first authenticates the input as to the origin of the data signal. The system then checks to see if the dealer has an active inventory process for the type of scan to be done, e.g., either new or used motor vehicle scan. If there is no active inventory process taking place, the inventory assist assembly discards the data signal and the method is terminated. If an active inventory process is being conducted, the data signal is identified as either a vehicle identification number 18 or a stock number 22 by the number of digits in the number received. The number is then uploaded from the inventory system of the dealer to determine whether it is in the system or not. The appropriate flag (in inventory system/in lot, not in inventory system/in lot, etc.) is applied to the vehicle record for later review by dealer personnel.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. An inventory assisting assembly for coordinating activity relating to the acts of receipt and inventory of motor vehicles in a lot wherein each of the motor vehicles has a vehicle identification number and a graphic representation of the vehicle identification number, said inventory assisting assembly comprising:
a wireless device capable of transmitting data signals using electromagnetic radiation;
a scanner operatively connected to said wireless device for scanning the graphic representation of the vehicle identification number and transmitting scanned data to said wireless device for converting said scanned data into said data signals for transmission; and
a server designed to receive said data signals from said wireless device and for transferring said data signals into a readable output identifying all characteristics of the motor vehicle that are encoded in the vehicle identification number.

2. An inventory assisting assembly as set forth in claim 1 including a printer electronically connected to said server for printing said readable output for use in relation to the motor vehicle.

3. An inventory assisting assembly as set forth in claim 2 including a remote computer electrically connected to said server for viewing said readable output and for data entry with respect to said readable output to embellish information associated with the motor vehicle.

4. An inventory assisting assembly as set forth in claim 3 wherein said wireless device includes an input pad to input the vehicle identification number as an alternative to scanning the graphic representation of the vehicle identification number.

5. A method for assisting in an inventory process of motor vehicles using a wireless device, a scanner secured thereto, a server, a printer and a remote computer, the method comprising the steps of:
inputting a vehicle identification number into the wireless device;
transmitting the vehicle identification number to the server;
decoding the vehicle identification number to extrapolate all information in the vehicle identification number to create a vehicle record of the motor vehicle;
transmitting the vehicle record to the remote computer; and
inputting additional information regarding the motor vehicle into the vehicle record and storing same therein.

6. A method as set forth in claim 5 including the step of printing the vehicle record from the printer.

7. A method as set forth in claim 6 wherein the step of printing includes the step of printing a window sticker to be adhered to a window of the motor vehicle.

8. A method as set forth in claim 6 wherein the step of printing includes the step of printing a plurality of keytags.

9. A method as set forth in claim 6 wherein the step of printing includes the step of printing a plurality of stickers to be subsequently affixed to papers and folders.

10. A method as set forth in claim 9 wherein the step of printing a plurality of stickers includes the step of printing a plurality of stickers in a plurality of different sizes.

11. A method as set forth in claim 5 including the step of identifying the location of the motor vehicle and adding the location to the vehicle record.

12. A method as set forth in claim 11 including the step of editing information in the vehicle record.

13. A method as set forth in claim 5 including the step of comparing the vehicle identification number as input against a stock list of vehicle identification numbers to ensure accuracy.

14. A method as set forth in claim 13 including the step of storing all edits and additions with the vehicle record.

15. A method for assisting in an inventory process of motor vehicles using a wireless device, a scanner secured thereto, a server, a printer and a remote computer, the method comprising the steps of:
inputting a vehicle identification number into the wireless device;
transmitting the vehicle identification number to the server;
decoding the vehicle identification number to extrapolate all information in the vehicle identification number to create a vehicle record of the motor vehicle;
transmitting the vehicle record to the remote computer;
inputting additional information regarding the motor vehicle into the vehicle record and storing same therein; and
comparing the vehicle identification number as input against a stock list of vehicle identification numbers to ensure accuracy.

16. A method as set forth in claim 15 including the step of printing the vehicle record from the printer.

17. A method as set forth in claim 16 including the step of editing information in the vehicle record.

18. A method as set forth in claim 17 including the step of storing all edits and additions with the vehicle record.

19. A method as set forth in claim 18 wherein the step of printing includes the step of printing a window sticker to be adhered to a window of the motor vehicle.

20. A method as set forth in claim 19 wherein the step of printing includes the step of printing a plurality of keytags.
